(19) United States
(12) Patent Application Publication
(10) Pub. No.: US 2021/0081909 A1
(43) Pub. Date: Mar. 18, 2021

(54) SYSTEM AND METHOD FOR REMINDING AND TRACKING USE OF REUSABLE CONTAINER AND CARRY PRODUCTS

(71) Applicant: Matthew Frank Wittek, Guelph (CA)

(72) Inventor: Matthew Frank Wittek, Guelph (CA)

(21) Appl. No.: 17/107,914

(22) Filed: Nov. 30, 2020

Related U.S. Application Data
(63) Continuation-in-part of application No. 14/492,986, filed on Sep. 22, 2014, now Pat. No. 10,853,832.
(60) Provisional application No. 61/880,477, filed on Sep. 20, 2013.
(60) Provisional application No. 62/003,359, filed on May 27, 2014.

(51) Int. Cl. G06Q 10/00; G06Q 10/08; G06Q 30/06; G06Q 30/00; G06Q 30/02; G06K 7/14; G06K 7/10; G06K 19/06; G06K 19/07; G06Q 20/32; G06Q 20/18; G06Q 20/20

(52) U.S. Cl. CPC G06Q 10/30; G06Q 10/109; G06Q 30/0633; G06Q 30/0645; G06Q 30/0623; G06Q 30/018; G06Q 30/0279; G06K 7/1413; G06K 7/1417; G06K 7/10297; G06K 19/06028; G06K 19/06037; G06K 19/0723; G06Q 20/3276; G06Q 20/18; G06K 19/06112; G06Q 20/203; G06Q 20/208; G06K 2007/10504; G06Q 30/0226; G06Q 10/087

(57) ABSTRACT

The present disclosure relates to a system and method for reusing reusable items and borrowing reusable items which can be checked out and returned. In an embodiment, the system is adapted to display a user selectable option for reusing one or more reusable items and a user selectable option for borrowing one or more reusable items; upon user selection of the option for reusing one or more reusable items, display one or more impacts resulting from the one or more user selections; and upon user selection of the option to borrowing one or more reusable items, display instructions for checking-out a borrowed item, notify that the borrowed item is successfully checked out, and display one or more impacts resulting from the one or more borrowed reusable items. In an embodiment, the reusable items comprise food containers and utensils.

### CROSS-REFERENCE TO RELATED APPLICATIONS

This is a continuation-in-part of U.S. patent application Ser. No. 14/492,986 filed on Sep. 22, 2014, claiming priority from U.S. Provisional Application No. 61/880,377 filed on Sep. 20, 2013, and U.S. Provisional Application No. 62/003,359 filed in May 27, 2014, copies of which are incorporated by reference herein in their entirety.

### FIELD OF THE INVENTION

The present disclosure relates generally to a system and method for reminding users to use, and tracking usage of, reusable container and carry products, such as reusable bags, boxes, cups, cup sleeves, and bottles.

### BACKGROUND

Presently, a wide range of reusable products are being promoted by various retailers and consumer products companies as a way to be more environmentally friendly, and to reduce unnecessary waste headed for garbage dumps, landfills, or to a garbage incinerator for destruction. For example, many grocery stores now offer reusable grocery bags in order to reduce the number of conventional plastic bags used for carrying customer groceries.

However, consumers often forget to bring their reusable container or carry products back to retailers on their next shopping trip, and either end up having to repeatedly buy additional reusable products, or asking for conventional, non-reusable container or carrying products instead. This can greatly diminish or defeat the effectiveness of the reusable products in reducing waste.

Furthermore, when reusable container or carry products are brought on shopping trips, it is difficult for retailers to determine usage patterns, or how effective their promotions involving reusable container or carry products may be.

Even when consumers remember to bring and reuse their reusable container or carry products, tracking the usage may be cumbersome of a consumer has to remember and manually track each reuse, for example, each time a reusable water bottle is reused.

Therefore, what is needed is an improved system and method for addressing at least some of these limitations in the prior art.

### SUMMARY

The present disclosure relates to a system and method for reminding users to use, and for tracking usage of, reusable container and carry products such as reusable bags, boxes, cups, cup sleeves, bottles, and other reusable items.

In an aspect, the system and method provides an electronic identification module which may be attached to or embedded within a reusable container or carry product. The electronic identification module may comprise, for example, a Radio Frequency Identification Device (RFID) which may be used to uniquely identify a reusable container or carry product. Other possible technologies for the electronic identification module include Near Field Communications (NFC) and Bluetooth, for example. Another type of unique identifier may also be used such as a bar code or a QR code.

The electronic identification module may be active or passive, and is preferably adapted to operatively connect with a mobile communication device or an adapter for such a mobile communication device. The mobile communication device may be, for example, a smart phone, smart watch, tablet, or some other device form factor.

In an embodiment, a calendar or alarm clock app running on the mobile communication device may be programmed to remind a user to bring along a reusable container or carry product in accordance with one or more entries in a calendar or an alarm clock app, or by detecting the geographic location of the mobile communication device.

In another embodiment, the electronic identification module attached to or embedded in a reusable container or carry product communicates with the mobile communication device, either directly or through a suitable adapter, such that usage of the reusable container or carry product can be recorded.

Alternatively, the electronic identification module attached to or embedded in a reusable container or carry product may communicate directly with a vendor's system at a retail location in order to track usage based on location of a retail store.

In another embodiment, the present system and method may be adapted to track usage of reusable containers or carry products, and to provide a reward or incentive for regular usage. For example, loyalty points may be collected each time a reusable container or carry product is used and may be redeemable to exchange for various rewards or prizes.

In another aspect, the present system and method allows tracking of the usage of reusable container or carry products by many users at a particular retail location, providing the retailer with feedback on how many of its customers are using reusable container or carry products. Alternatively, the present system and method allows tracking and usage of reusable container or carry products associated with a particular consumer brand company, allowing the company to collect statistics that are not necessarily tied down to one retailer.

In another embodiment, the electronic identification module may be adapted to be integrated with a mobile communication device such that a secure payment module on the mobile communication device may be used to pay for an item being carried or stored in a reusable container.

In another aspect, the present system and method promotes use of reusable items using a mobile communication device, and includes a reminder module for reminding a user to bring a reusable item; a reward module for rewarding the user for bringing the reusable item; and a tracking module for tracking use of the reusable item.

In another aspect, the present system and method is adapted to automatically track reuse of an item by incorporating a wearable or pocketable tracking device, such as an RFID or Bluetooth enabled wrist band, necklace, ring, watch, a fob attached to a keychain being carried in a pocket, glasses, or any other item commonly worn or carried by consumers.

In an embodiment, the RFID or Bluetooth enabled wearable tracking device is adapted to pair with RFID or Bluetooth enabled tags or stickers attached to various reusable items, such as a refillable water bottle, a reusable bag, or clothing that is recycled or made of ecologically friendly materials. The RFID or Bluetooth enabled wearable tracking device is also paired with a computing device, embodied in a mobile communication device, such as a smart phone, smart watch, or tablet.

In use, a wearable tracking device paired with one or more RFID or Bluetooth enabled tags or stickers automatically tracks each instance a reusable item is reused. This reuse data is also collected by a paired mobile communication device which automatically tracks the environmental impact each time a tag to reusable item is reused.

Advantageously, the wearable tracking device facilitates automatic tracking of reusing reasonable items, and therefore provides virtually real-time tracking of the environmental impact of reuse to the consumer, which tracking data may also be shared with others.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a schematic block diagram of a system architecture in accordance with an embodiment.

FIG. 2 shows a schematic block diagram of a generic computer device in accordance with an embodiment.

FIG. 3 shows a schematic flow chart of an illustrative method in accordance with an embodiment.

FIGS. 4A and 4B illustrate an overview of a method and system for reminding, rewarding, and educating consumers on the ecological impact of their use of reusable containers or carry products.

FIGS. 5A to 5C show screen captures of a mobile device for illustrating setting reminders for reuse, earning rewards for reuse, and tracking ecological impact of reuse.

FIG. 6 shows screen captures of a mobile device for illustrating targeted brand advertising to customers in a store.

FIGS. 7A to 7L show screen captures of a mobile device for illustrating the method and system in use in accordance with an embodiment.

FIG. 8 shows an illustrative example of a wearable tracking device, such as an RFID or Bluetooth enabled wrist band, which may be paired with RFID or Bluetooth enabled tags or stickers.

FIG. 9 shows an illustrative example of the wearable tracking device being worn.

FIG. 10 shows an illustrative example of RFID or Bluetooth enabled tags or stickers which may be applied to a wide range of ecologically friendly items.

FIG. 11 shows an illustrative example of pairing a wearable tracking device with one or more RFID or Bluetooth enabled tags or stickers.

FIG. 12 shows an illustrative screen capture of a mobile device tracking a user's environmental footprint.

FIG. 13 shows illustrative screen captures of a mobile device tracking a charitable impact of the user's reuse of reusable items.

FIG. 14 shows an illustrative example of reusing items utilizing tags or stickers in accordance with an embodiment.

FIGS. 15A to 15K show screen captures of a mobile device illustrating a method and system for reusing in accordance with an embodiment.

FIGS. 16A to 16C show illustrative drop off locations for items being reused.

FIG. 17 shows an illustrative block diagram of a kiosk in accordance with an embodiment.

FIGS. 18A to 18D show a schematic flow of how a user may interact with with the kiosk in accordance with an embodiment.

### DETAILED DESCRIPTION

As noted above, the present disclosure relates to a system and method for reminding users to use, and tracking usage of, reusable container and carry products, such as reusable bags, boxes, cups, cup sleeves, and bottles.

In an aspect, the system and method provides an electronic identification module which may be attached to or embedded within a reusable container or carry product. The electronic identification module may comprise, for example, an electronic Radio Frequency Identification Device (RFID) tag, a security chip, or other electronic means which may be used to uniquely identify a reusable container or carry product.

The electronic identification module may be active, semi-passive, or passive, and is preferably adapted to operatively connect with a mobile communication device such as a smart phone, smart watch, tablet, or some other device form factor. The mobile communication device may require an adapter to interact with RFID, NFC, Bluetooth devices or tags, or other types of unique identifiers, or may have these capabilities built directly into the mobile communication device.

In an embodiment, an app running on the mobile communication device may be programmed to remind a user to bring along a reusable container or carry product in accordance with one or more entries in a calendar or alarm system. For example, if a user regularly visits a coffee shop each weekday morning, an automatic reminder may be programmed to alert the user shortly before the user is scheduled to leave the house. If a user schedules a regular visit to the grocery store on a weekly basis, then an automatic reminder may be programmed to alert the user to bring along one or more reusable grocery bags shortly before the regular time.

In an embodiment, the electronic identification module attached to or embedded in a reusable container or carry product communicates with the mobile communication device, such that usage of the reusable container or carry product can be recorded. For example, the electronic identification module may be attached to or embedded in a reusable container such as a coffee cup. Each time the reusable coffee cup is reused at a coffee shop, the electronic identification module uniquely identifying the reusable coffee cup can be scanned, and usage of the coffee cup can be recorded in a database collecting historical usage information.

Alternatively, the electronic identification module attached to or embedded in a reusable container or carry product may communicate directly with a vendor's system at a retail location in order to track usage based on location of a retail store. This would allow a retail store to track usage of its reusable container or carry product even if the retail store does not know the identity of the user. As an example, an RFID sensor may be placed near the entrance to a retail store to sense any RFID tags attached or embedded within any reusable container or carry products being carried into the store. Optionally, upon associating an RFID tag with a user through the user's communication device, the retail store may then track the identity of the individual coming into the store based on the RFID tag.

In an embodiment, the present system and method may be adapted to track usage of reusable containers or carry products, and to provide a reward or incentive in accordance with points collected in a loyalty program. For example, rather than having a loyalty card, frequent usage of a reusable coffee cup may be tracked and rewarded, for example with a free coffee after every 10 cups purchased using the reusable coffee cup.

In another respect, the present system and method allows tracking of the usage of reusable container or carry products by many users at a particular retail location, providing the retailer with feedback on how many of its customers are using reusable container or carry products. Alternatively, the present system and method allows tracking and usage of reusable container or carry products associated with a particular consumer brand company, allowing the company to collect statistics that are not necessarily tied down to one retailer.

In another embodiment, the electronic identification module may be adapted to be integrated with a mobile communication device such that a secure payment module on the mobile communication device may be used to pay for an item being carried or stored in a reusable container. For example, an electronic identification module embedded in a coffee cup may be adapted to be identified by a secure payment module on a user's mobile communication device as being a large-size coffee container. Based on pricing information supplied by a retailer for a large coffee, the payment may be made automatically at a checkout location, with or without a cashier.

In another aspect, the present system and method allows retailers and consumer products companies to track usage of reusable container or carry products that they may distribute, in order to determine how successful a marketing campaign has been. In addition, by bringing along a reusable container or carry product with an electronic identification module associated with a particular retailer, or with a particular consumer products company, the retainer or company can make special offers to a user through an app running on the mobile communication device.

In another embodiment, in addition to or in lieu of the electronic identification module, an optical identification means such as barcodes or QR codes may also be used to mark the reusable container or carry product. Such a barcode or QR code may be read both by the user's mobile communication device, and a vendor's in store system.

In another aspect, the present system and method is adapted to automatically track reuse of an item by incorporating a wearable tracking device, such as an RFID or Bluetooth enabled wrist band, necklace, ring, watch, glasses, or other item commonly worn by consumers.

In an embodiment, the RFID or Bluetooth enabled wearable tracking device is adapted to pair with RFID or Bluetooth enabled tags or stickers attached to various reusable items, such as a refillable water bottle, a reusable bag, or clothing that is recycled or made of ecologically friendly materials. The RFID or Bluetooth enabled wearable tracking device is also paired with a computing device, embodied in a mobile communication device, such as a smart phone, smart watch, or tablet.

In use, a wearable tracking device paired with one or more RFID or Bluetooth enabled tags or stickers automatically tracks each instance a reusable item is reused. This reuse data is also collected by a paired mobile communication device which automatically tracks the environmental impact each time a tag to reusable item is reused.

The present system and method will now be described in more detail with reference to the figures.

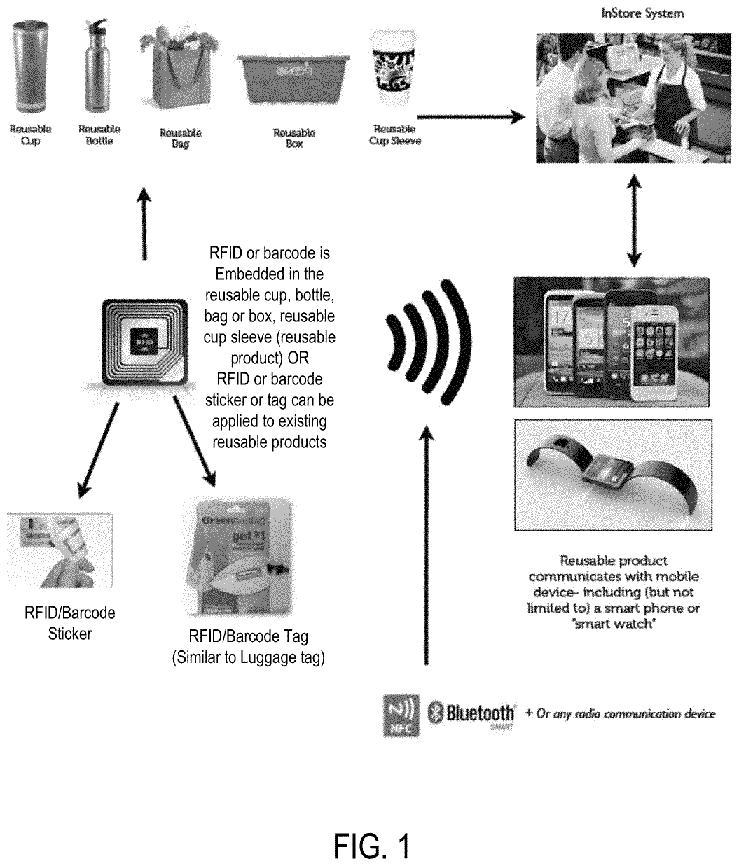

Shown in FIG. 1 is a schematic block diagram of an illustrative system architecture in accordance with an embodiment. As shown, various reusable container and carry products may include a reusable cup, cup sleeve, bottle, bag or box, for example. These various reusable container and carry products may include an RFID embedded directly into the products, or alternatively an RFID sticker or tag (or anything that may be attached) that may be attached to the reusable container or carry product. The RFID may be an active type powered by a battery, a battery assisted passive type, or a passive type with no power source. Operating distance of the embedded or attached RFID may range from about 100 meters for an active RFID type, to about 10 meters for a passive RFID type. With a suitable battery, an active RFID chip may be powered for up to a number of years, adequately covering the expected life of a reusable container or carry product. Therefore, whether attached to a reusable container or carry product as a tag or sticker, or embedded within the reusable container or carry product, the RFID provides an effective way to track the reusable container or carry product.

In an embodiment, the present system and method may periodically check to confirm if a reusable container or carry product is within range of an RFID sensor on a mobile communication device, and to alert a user of a mobile communication device if the reusable container or carry product is out of range.

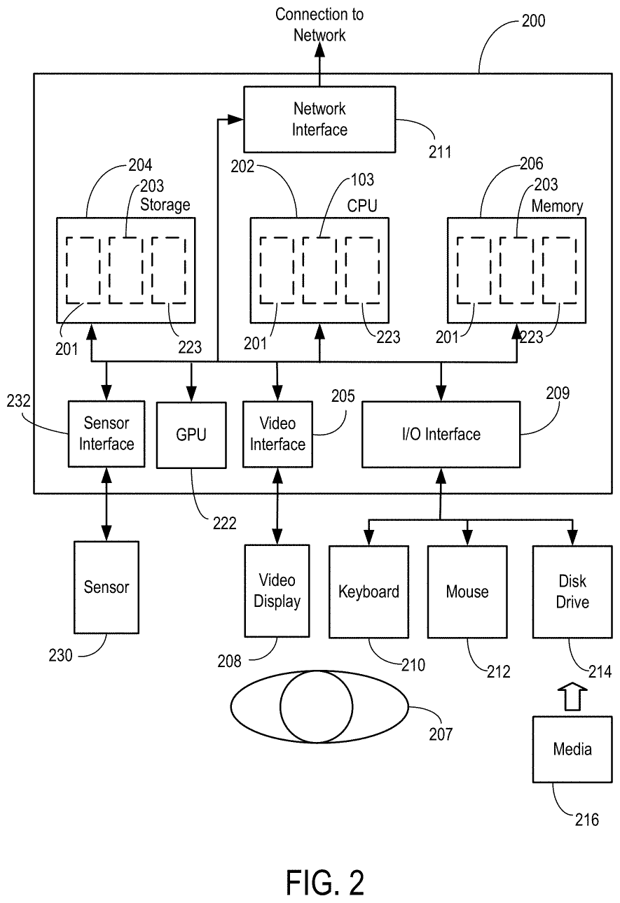

Now referring to FIG. 2, the present system and method may be practiced in various embodiments. A suitably configured computer device, and associated communications networks, devices, software and firmware may provide a platform for enabling one or more embodiments as described above. By way of example, FIG. 2 shows a generic computer device 200 that may include a central processing unit (“CPU”) 202 connected to a storage unit 204 and to a random access memory 206. The CPU 202 may process an operating system 201, application program 203, and data 223. The operating system 201, application program 203, and data 223 may be stored in storage unit 204 and loaded into memory 206, as may be required. Computer device 200 may further include a graphics processing unit (GPU) 222 which is operatively connected to CPU 202 and to memory 206 to offload intensive image processing calculations from CPU 202 and run these calculations in parallel with CPU 202. An operator 207 may interact with the computer device 200 using a video display 208 connected by a video interface 205, and various input/output devices such as a keyboard 210, pointer 212, and storage 214 connected by an I/O interface 209. In known manner, the pointer 212 may be configured to control movement of a cursor or pointer icon in the video display 208, and to operate various graphical user interface (GUI) controls appearing in the video display 208. The computer device 200 may form part of a network via a network interface 211, allowing the computer device 200 to communicate with other suitably configured data processing systems (not shown). One or more different types of sensors 230 connected via a sensor interface 232 may be used to search for and sense input from various sources. The sensors 230 may be built directly into the generic computer device 200, or optionally configured as an attachment or accessory to the generic computer device 200.

One or more application programs 203 on the generic computer device 200 may be adapted to perform the functions described in this specification, including but not limited to a scanning module for scanning for and sensing an electronic identification module, a reminder module for reminding use of a reusable container or carry product, a tracking module for tracking use of a reusable container or carry product at a retail store, and a vendor interface module for interacting with a vendor's system. The one or more application programs 203 may be adapted to interact with any of the components of the generic computer device 200 as may be necessary to perform their intended functions.

The present system and method may be practiced on virtually any manner of mobile computer device including laptop computer, tablet, smart phone or smart watch. The present system and method may also be implemented as a computer-readable/useable medium that includes computer program code to enable a computer device to implement each of the various process steps in a method in accordance with the present invention. It is understood that the terms computer-readable medium or computer useable medium comprises one or more of any type of physical embodiment of the program code.

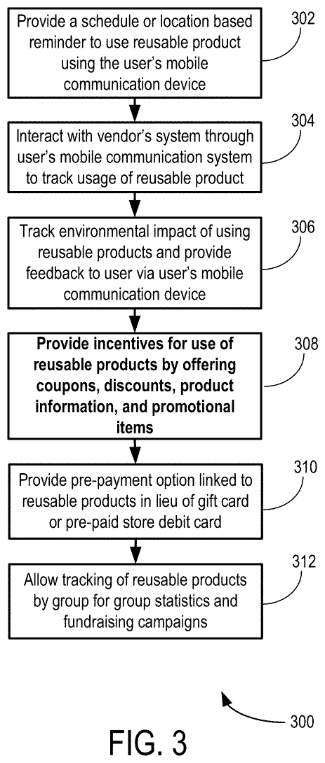

Now referring to FIG. 3, shown is a schematic flow chart of an illustrative method 300 in accordance with an embodiment. As shown, method 300 begins at block 302, where method 300 provides a schedule or location based reminder to use reusable product using the user's mobile communication device.

At block 304, method 300 interacts with vendor's system through user's mobile communication system to track usage of reusable product.

At block 306, method 300 tracks environmental impact of using reusable products and provide feedback to user via user's mobile communication device.

At block 308, method 300 provides incentives for use of reusable products by offering coupons, discounts, and promotional items.

At block 310, method 300 provides a pre-payment option linked to reusable products in lieu of gift card or pre-paid store debit card.

At block 312, method 300 allows tracking of reusable products by group for group statistics and fundraising campaigns.

Various illustrative examples will now be described to explain the features and functions of the present system and method in more detail.

Schedule Based Reminder System—In a first illustrative example, the present system and method may provide a schedule based reminder system provided on the user's mobile communication device. For example, suppose that a user is a regular customer of a local coffee shop on weekday mornings. Before leaving his or her home, an app on the user's smart phone is pre-programmed to remind the user to bring a reusable container or coffee cup each weekday morning. This reminder may be provided in any number of ways, including an alarm clock function, an email reminder, a text message, or some other means by which the user will be alerted each weekday morning. As a further incentive to bring along the reusable coffee cup to the coffee shop, the reminder via the user's smart phone may notify the user that they have a free coffee that day given the number of cups of coffee previously purchased, or that they need only one more purchase using the reusable container before qualifying for a free cup of coffee. Alternatively, a coupon for a discounted cup of coffee or a free coffee may be sent to the user along with their daily reminder in order to provide an incentive for the user to bring along the reusable container.

Location Based Reminder System—As another example, the user's smart phone may be adapted to provide a location based reminder system. For example, the user's smart phone may be adapted to detect whether or not a reusable coffee cup is within its vicinity using an electronic identification module sensor. If a reusable coffee cup is not detected within range as a user enters a car and prepares to leave for work, an alert may be raised for the user to retrieve the reusable coffee cup before departing the house. Alternatively, the user's smart phone may use a GPS based reminder system to send a reminder to the user to bring a reusable product as they leave the house, or as they leave their car in a parking lot of a retailer. This GPS based reminder system may be combined with the detection of the electronic identification module within range of the smart phone to determine whether or not to issue an alert.

Interaction with Vendor's System—As the user arrives at the coffee shop, the user's smart phone may communicate with the coffee vendor's in store system. Alternatively, the user's smart phone may also communicate with a coffee vendor's remotely located system accessible via the mobile Internet. The user's smart phone is also able to operatively connect to the electronic identification device in the reusable coffee cup, such that the identity of the reusable coffee cup is readily known to the vendor's system. If the coffee vendor's system cannot directly sense the electronic identification module embedded in the coffee cup, an app on the smart phone may provide a way for the identity of the reusable coffee cup to be made available via another format, such as a conventional barcode or a two-dimensional barcode system such as the Quick Response (QR) code.

In an embodiment, the interaction between the vendor's system, the user's smart phone, and the embedded electronic identification device in the reusable coffee cup is substantially automated, such that minimal effort is required on the part of the user or vendor to keep track of the number of times the coffee cup has been reused. This minimal effort may require the user to ensure that the short range communication features on the mobile communication device are turned on such that the mobile communication device may interact wirelessly with the vendor's system, and that a tracking app is currently active for tracking the usage of the reusable container. For added security, the user's smart phone may be equipped with a biometric sensor such as a fingerprint sensor, or other security feature such as facial image recognition before the tracking app on the user's mobile communication device and the vendor's system is permitted to connect.

Environmental Impact Tracking—In another aspect, the present system and method may provide users with a way to track the environmental impact that they have had by using a reusable product. For example, the tracking may provide feedback on how many plastic or paper bags, or disposable cups have they eliminated from landfill, how many trees they have saved, what the CO2 reduction is, etc. This could apply to a single user, or a group of users at a store, a school, a community group, or even a country.

Coupons—Either in conjunction with the schedule based or location based reminder systems described above, or independently, the present system and method may be adapted to provide incentives to keep and use the reusable container and carry products. For example, users can receive automatic coupons, discounts, loyalty points, or recipes at home or when they are using their reusable container or carry product at a store.

Significantly, rather than being tied to a particular retailer, a consumer product company can establish a direct line of communication with a user of the reusable container or carry product to promote the company's consumer products. For example, a user may receive a branded soup bag from the soup manufacturer. When user uses the reusable bag at a store, they can receive an automatic coupon and/or recipe for the soup manufacturer's products via the user's smart phone. This may be initiated by the user through an app on their smart phone, by scanning a barcode or tapping on the electronic identification module on the reusable container or carry product with their mobile communication device, or initiated automatically as the user enters a retail store.

As another example, a retail store may provide a store branded reusable shopping bag and may offer a discount on the retail store's products each time the reusable shopping bag is used.

As another example, a user may receive a reusable shopping bag from a cable company promoting video on demand services which enables a user of the reusable shopping bag to download coupons for popcorn or candy from their local retail location, or free movies that may be downloaded online or through the cable system box.

As another example, a local coffee chain may advertise a 50% coupon for a menu item between 2 and 4 pm on each day, if a user brings along a reusable coffee cup. Each day the user could tap their coffee cup with an embedded electronic identification module to see what the deal of the day is. Other promotional programs offered by the coffee chain may be customized for reusable coffee cups only, such that prizes may only be available to reusable coffee cup users. If a particular prize is to be rewarded based on the customer's number (e.g. the 25th customer to use a reusable coffee cup in a coffee vendor's location on a particular day), then the vendor's in store system may be adapted to keep track of usage and to notify the winner as they order or pay for their coffee.

As another example, the present system and method facilitates fundraising by allowing tracking of usage of reusable container and carry products by a large group of users. For example, a school undertaking a fundraising campaign may distribute reusable container or carry products to parents and the local school community. Each time the reusable container is used at a local retailer, the retailer or brand may contribute a part of their proceeds towards a particular fundraising campaign or charity. This could be based on the total dollars spent at the retail locations, or simply counting the number of visits to the local retailer which has agreed to contribute a set dollar amount to the fundraising campaign or charity.

Pre-Payment—In another aspect, the present system and method allows a secure means of pre-paying for products or services utilizing the electronic identification module. This may allow a gift of not just the reusable container or carry product, but also goods that can be carried or contained by the reusable container or carry product. For example, a reusable coffee cup may be associated with pre-payment for ten cups of coffee which may be claimed at a corresponding coffee vendor. As another example, a shopping bag for a retailer may have a pre-payment stored within its electronic identification module which may replace a gift card. This may be a grocery store, or another retail store such as a women's clothing store, for example.

In another embodiment, rather than storing and tracking pre-payment information directly within a storage means in the electronic identification module, the electronic identification module need merely uniquely identify the reusable container or carry product, such that the appropriate value of goods may be redeemed over time after the pre-payment is verified remotely on a remotely located vendor system. This may provide the vendor with more control, and prevent fraudulent loading of pre-payment information within an electronic identification module.

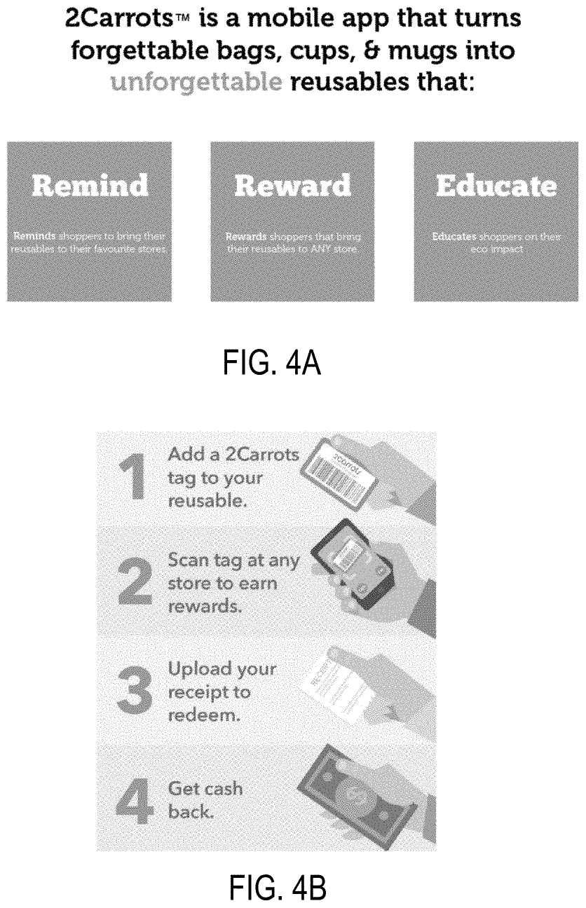

In summary, as graphically illustrated in FIGS. 4A and 4B, the present system and method is adapted to provide the following features and functions:

1) Remind customers to bring their reusable container and carry products with them;
2) Offer rewards or incentives for customers to keep and reuse their reusable container and carry products by providing discounts, product information, and coupons for goods and services when using their reusable products; and
3) Track and educate the environmental impact a customer or community is making by using reusable container and carry products.

In addition, the system and method may be adapted to offer fundraising incentives for a group of customers to use reusable products together.

By encouraging and facilitating use of reusable container and carry products, the system and method offers savings through coupons or discounts, or by not having to pay for the number of bags used. The system and method can also be used to provide product information, prizes, support fundraising efforts, and educate users regarding the environmental impact they are having.

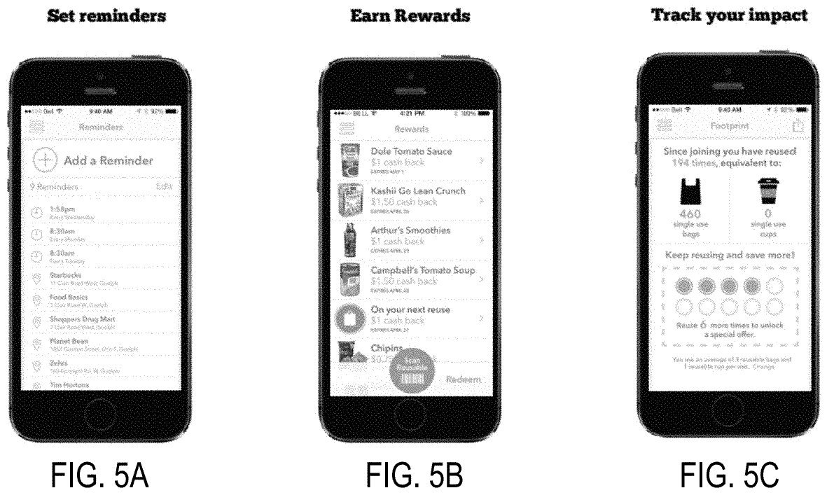

FIGS. 5A to 5C show screen captures of a mobile device for illustrating setting reminders for reuse, earning rewards for reuse, and tracking ecological impact of reuse.

Referring to FIG. 5A, reminders may be set for a particular time, for a particular store, and may be repeated regularly. For example, a reminder may be provided each morning at a set time to bring a reusable coffee mug for the regular coffee shop during the morning commute into work. As another example, a reminder may be provided weekly for a regular trip to the grocery store.

Referring to FIG. 5B, rewards may be offered for specific products when the user arrives onsite with a reusable container or carry product. For example, a reusable coffee cup may provide the user with a discount at the coffee shop, or a free coffee after buying a specified number of cups of coffee at the location, as tracked by the system. In a grocery store or a drug store, the system and method may advertise specific branded products available for bringing a reusable container or carry product, and scanning the identification module upon arrival at the store. This provides a further incentive for the user to remember to bring their reusable container or carry product each and every time.

FIG. 5C shows an illustrative example of a screen showing the positive ecological impact resulting from the user's reuse. In addition to coupons and promotional items offered by brands at a store, regular reuse of a reusable container or carry product may also trigger a special offer upon reaching a specified number of reuses.

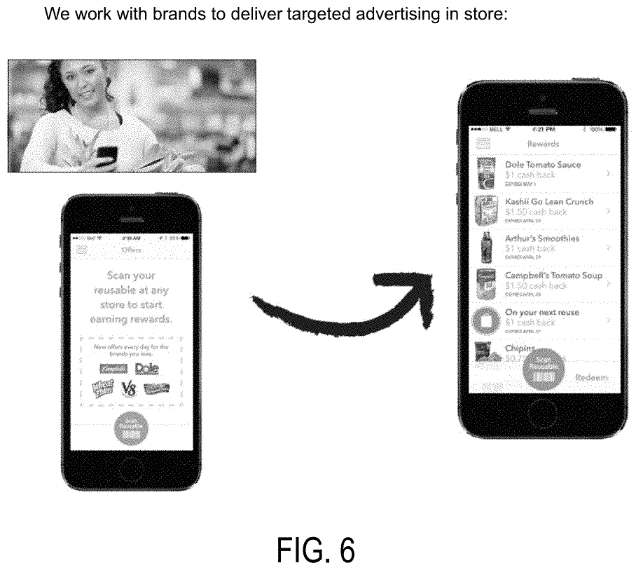

Now referring to FIG. 6, shown is an illustrative example of targeted brand advertising delivered to users/customers when they scan an identification module of a reusable container or carry product at a store. Multiple branded products may be offered to provide the user with a choice on which products to purchase on a shopping trip.

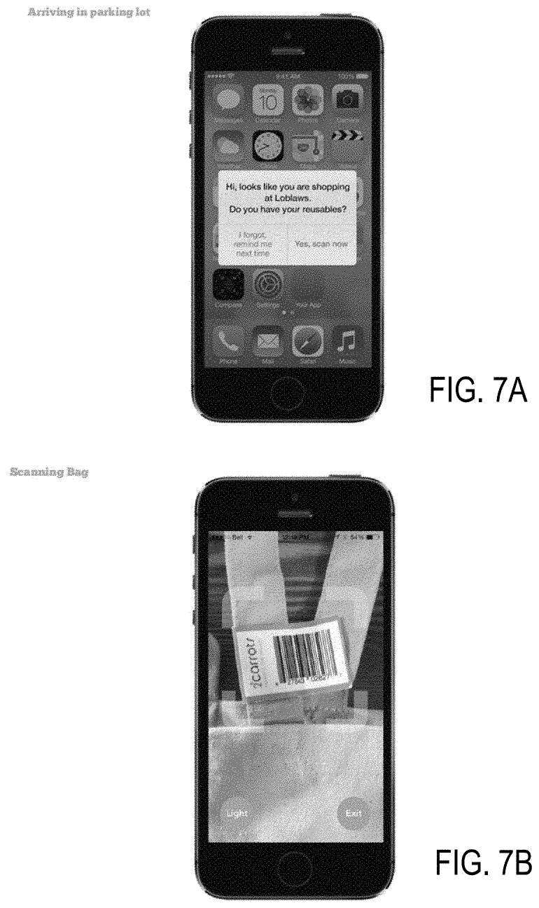

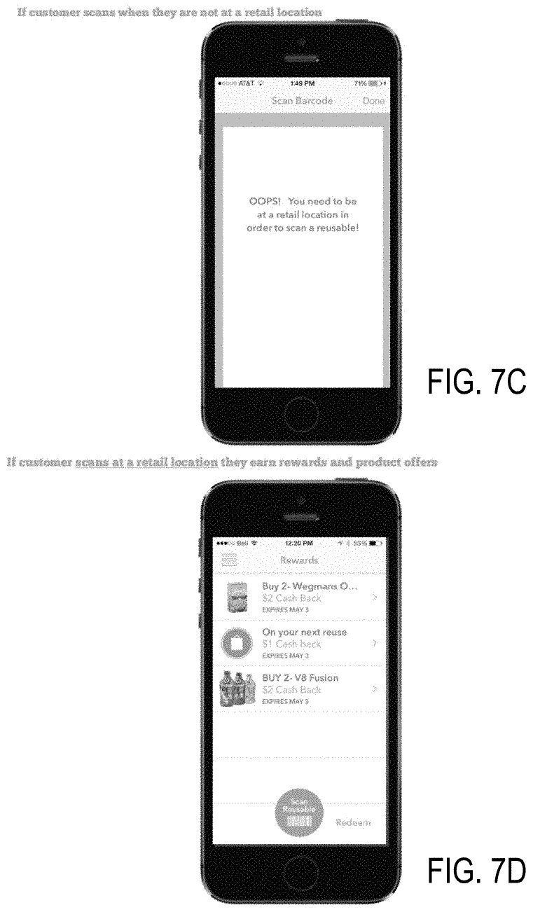

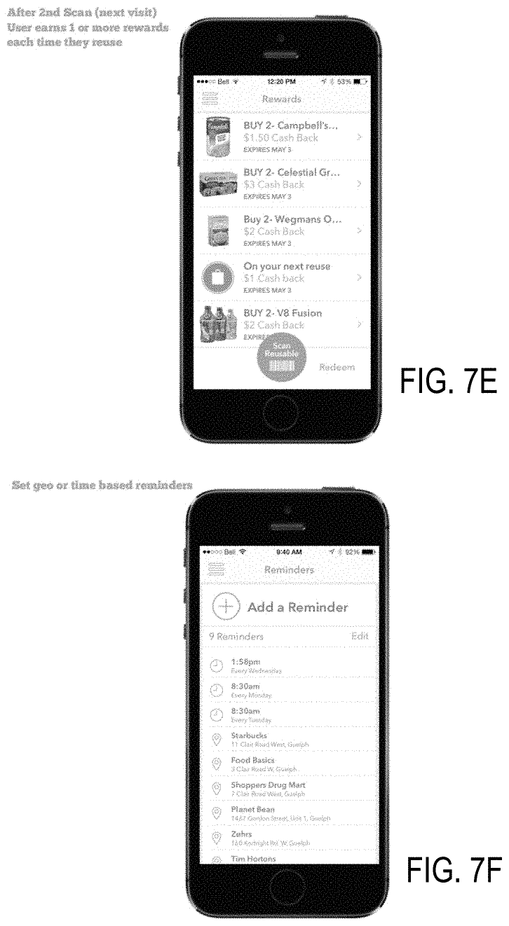

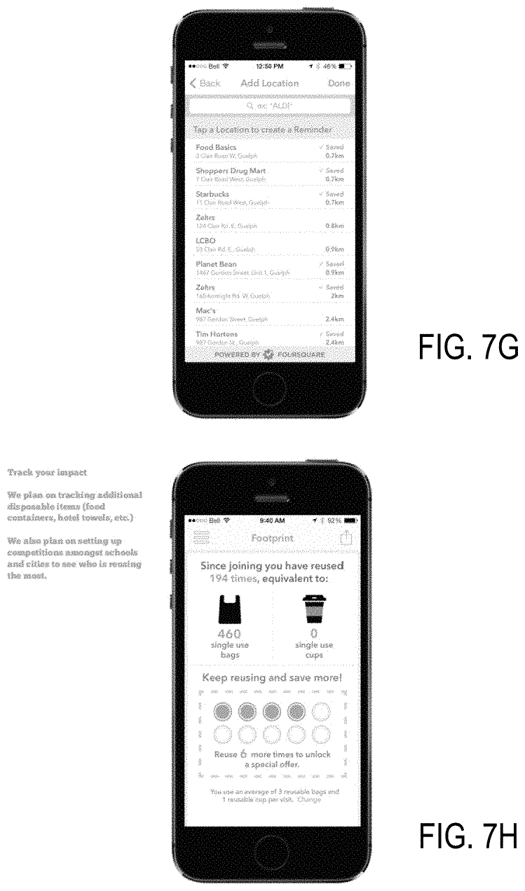

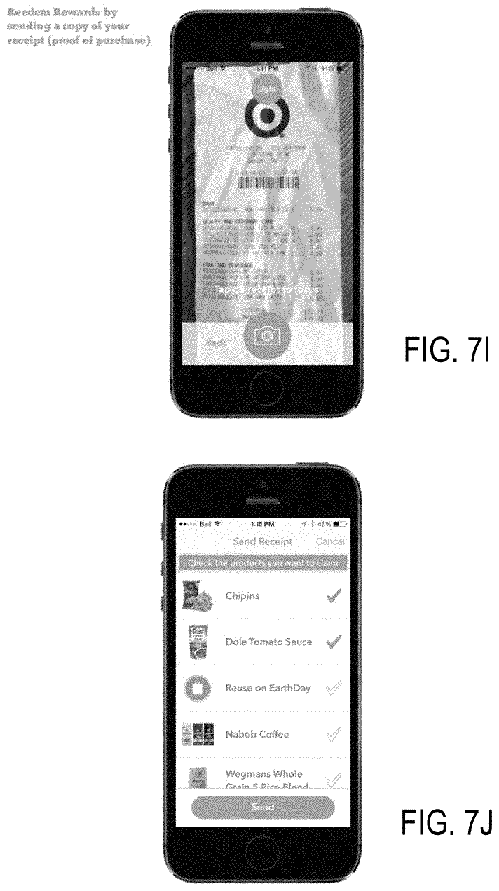

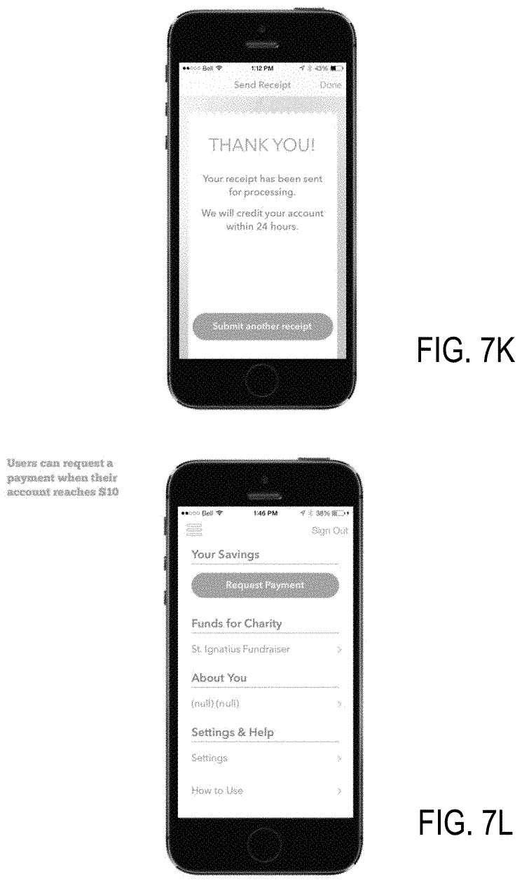

Now referring to FIGS. 7A to 7L, shown are screen captures of a mobile device for illustrating the method and system in use in accordance with an embodiment.

Referring to FIG. 7A, upon arrival at a parking lot, the system and method is adapted to trigger an alert, in a pop-up window for example, to remind the user to scan the identification module of their reusable container or carry product. If the user has forgotten to bring their reusable container or carry product in this trip, they can indicate that they have forgotten it, and request a reminder to bring it on the next shopping trip.

FIG. 7B illustrates scanning of the identification module, which in this illustrative example is a bar code tag attached to the strap of a reusable shopping bag. The system and method is configured to use the identification module to track reuse of the reusable shopping bag, and to track incentives offered through the system and method, and purchased by the user. Many other forms of identification modules are possible, including various types of wireless electronic identification modules as previously mentioned.

FIG. 7C shows an illustrative example of the system and method displaying an error message if a user attempts to scan the identification module while not at a retail location. This may be done to encourage the user to first come to the retail location before they can learn which promotions and incentives may be available. However, in an alternative embodiment, the system and method may allow the user to identify a particular store from home before making a trip, to see if there are any promotional items that would make the trip to the store worthwhile.

FIG. 7D shows an illustrative example of the system and method displaying rewards and product offers for scanning the identification module of the reusable container or carry product at a retail store. In an embodiment, certain rewards or product offers may be offered for a limited time, such as being available only during a particular shopping trip. Other rewards or product offers may be offered for an extended period, and may be saved in the system for use on the next shopping trip, for example.

FIG. 7E shows an illustrative example of the system and method displaying rewards or product offers that may increase on a second or subsequent visit, such that users earn more rewards for more frequent reuse of reusable containers and carry products at a particular store.

Now referring to FIGS. 7F and 7G, shown is an illustrative example of the system and method displaying screens for adding one or more reminders. Certain reminders may be set based on time, while other reminders may be set based on the geographic location. Thus, for example, arriving in the parking lot of a particular store may set off a geographically triggered reminder to scan and bring in a reusable container or carry product.

Now referring to FIG. 7H, shown is an illustrative example of the system and method displaying the positive ecological impact of the user's reuse of containers and carry products. In this illustrative example, the system and method counts the number of times a reusable container or carry product has been used, and may provide the equivalent number of single use containers or carry products which have been saved from becoming garbage.

FIG. 7I shows an illustrative example of the system and method displaying a screen for taking a digital image of a store receipt for providing proof of purchase of a product which is eligible for a reward or promotional offer. This option allows a brand manufacturer or seller to readily honour a coupon or promotion without necessarily having to rely on participation from a retailer carrying their products. The brand manufacturer or seller thus is able to reimburse a consumer directly through the present system and method. In an alternative embodiment, participation of a retailer may allow the consumer to receive a discount at the point of sale at the store's check-out.

Now referring to FIG. 7J, shown is an illustrative example of the system and method displaying receipts that have been stored for sending to a brand manufacturer or seller. This option allows the user to collect a number of receipts and send for reimbursement at the same time, rather than sending the receipts for each item.

FIG. 7K shows an illustrative example of the system and method displaying a screen for confirming that one or more receipts have been sent for processing by the system and method. In an embodiment, the system and method may be configured to credit payment to a user's account on the system. In order to avoid excessive transactional charges on relatively small amounts, FIG. 7L shows an illustrative example of the system and method displaying a screen in which users can request a payment only after reaching a certain predetermined amount, such as $10 for example. The payment may be made to a user's bank account, a debit card, or through an online payment system such as PayPal®, for example. The user may also be provided with an option to alternatively send the requested amount to a charity in lieu of receiving the payment themselves.

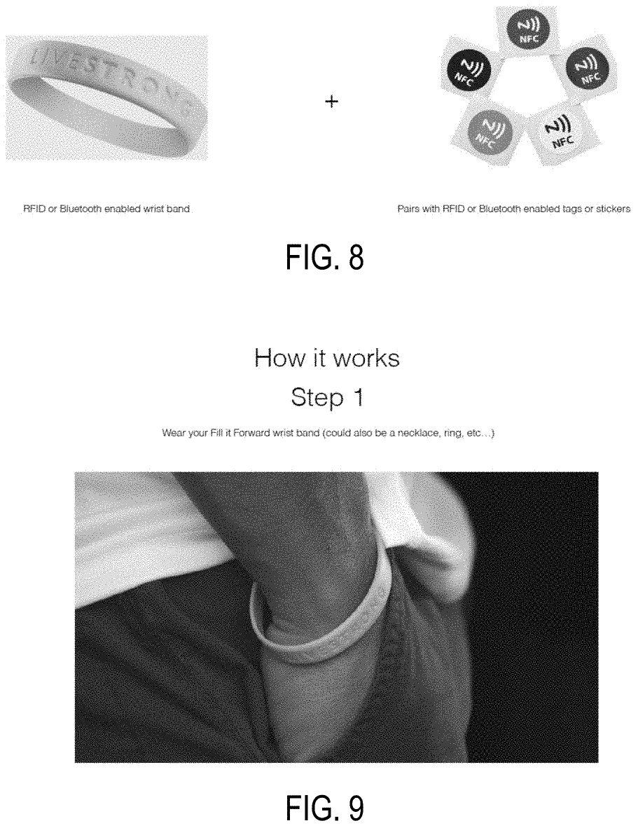

Now referring to FIG. 8, shown is an illustrative example of a wearable or pocketable tracking device, such as an RFID or Bluetooth enabled wrist band, which may be paired with RFID or Bluetooth enabled tags or stickers. While a wristband being worn is shown by way of an illustrative example in FIG. 9, it will be appreciated that the wearable tracking device may be any item commonly worn or carried by a user or consumer, such as a necklace, ring, watch, or fob attached to a keychain being carried in a pocket.

In an embodiment, the wearable or pocketable tracking device is adapted to be paired with one or more RFID or Bluetooth enabled tags or stickers that are attached to a wide range of ecologically friendly items, such as refillable bottles, reusable bags, and clothing made from ecologically friendly materials, as shown by way of example in FIG. 10.

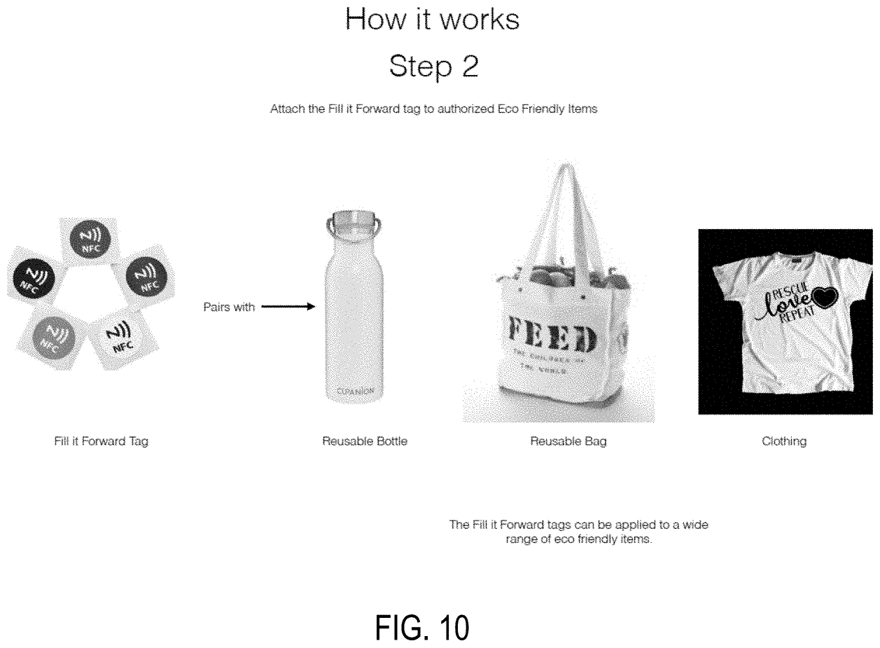

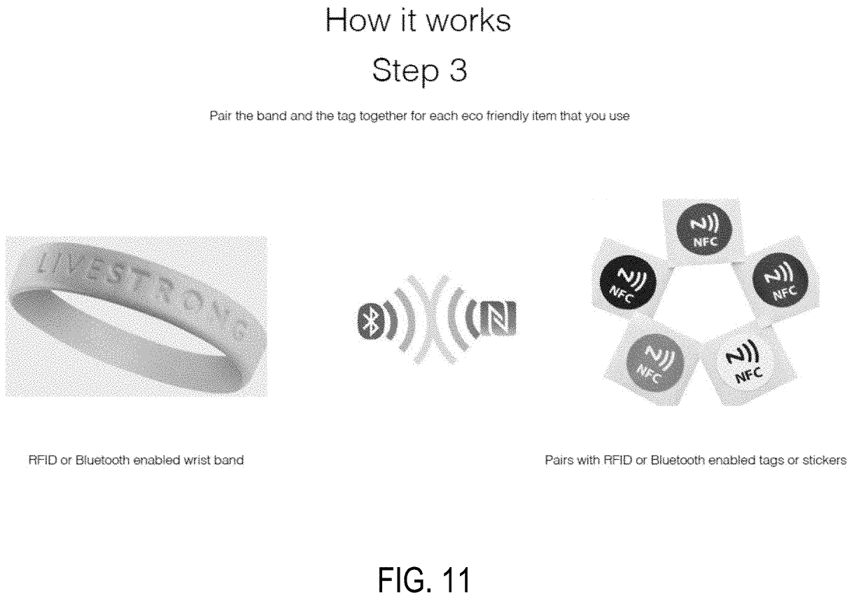

Now referring to FIG. 11, shown is an illustrative example of pairing a wearable tracking device with one or more RFID or Bluetooth enabled tags or stickers. In an embodiment, the RFID or Bluetooth enabled wearable tracking device is adapted to pair with the one or more RFID or Bluetooth enabled tags or stickers attached to various reusable items, such as a refillable water bottle, a reusable bag, or clothing that is recycled or made of ecologically friendly materials. The RFID or Bluetooth enabled wearable tracking device is also paired with a computing device, as embodied for example in a mobile communication device, such as a smart phone, smart watch, or tablet.

In use, the wearable tracking device paired with one or more RFID or Bluetooth enabled tags or stickers automatically tracks each instance a reusable item is reused. For example, in the context of a reusable refillable water bottle, the wearable tracking device may be adapted to detect each instance that a water bottle is lifted by including sensors to detect a motion representative of the water bottle being lifted to a user's mouth. The wearable tracking device may also sense a motion representative of the water bottle being held upside down, indicative of the water bottle being emptied. Based on a calculation of the time that has elapsed since the water bottle was last refilled, the present system and method may be adapted to detect when a reusable water bottle is being refilled.

In an embodiment, to automate the tracking process, the present system and method may be configured to process when it detects that a water bottle has been refilled, and presents this information to a user, for example on the user's mobile device, to verify that the water bottle has been refilled. By prompting the user in this manner, the system and method automates the tracking process and relieves the user from having to remember to input that a water bottle has been refilled.

Advantageously, the wearable tracking device therefore facilitates automatic tracking of reusing reusable items, and is able to provide virtually real-time tracking of the environmental impact of reuse to the consumer, which tracking data may also be shared with others.

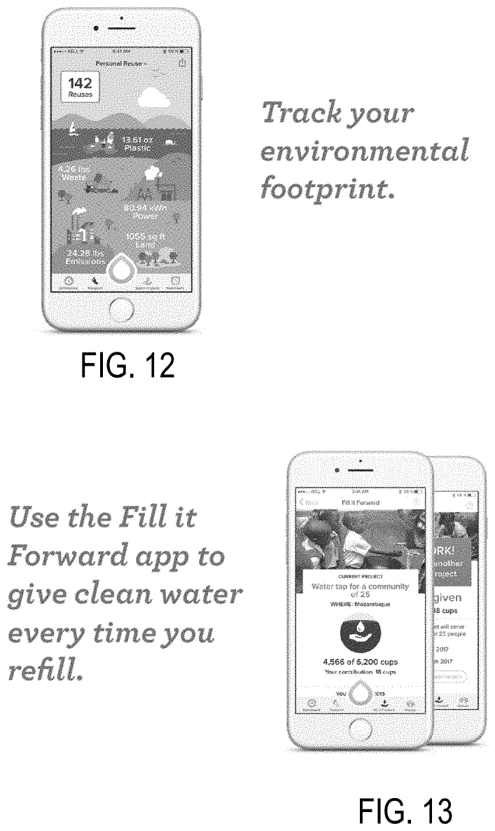

By way of example, FIG. 12 shows an illustrative screen capture of a mobile device tracking a user's environmental footprint in virtually real-time. For example, the environmental impact of reusing a refillable water bottle may be represented by various environmental impacts such as the weight of nonreusable plastics that may end up in the ocean, the weight of nonreusable plastics that may otherwise end up in a dump, the amount of energy saved by not having to manufacture nonreusable plastics, the amount of carbon emissions saved, and the amount of land that may be conserved by reusing a refillable water bottle. This impact may also be tracked across a larger group of users who are all using refillable water bottles, and who wish to track their environmental footprint as a group.

As a another illustrative example, FIG. 13 shows screen captures of a mobile device tracking a charitable impact of the user's reuse of reusable items. In this example, the system and method of the present invention may track charitable giving of drinking water to communities through various water giving projects as a result the user's reuse of a reusable, refillable water bottle.

While water donation has been used as an illustrative example, it will be appreciated that various other charitable programs may established as well, such as food donations to food banks for reusing reusable grocery bags, or donation of clothing for wearing ecologically friendly clothing.

### Check-Out Method and System

In another aspect, the present disclosure relates to a check-out method and system which may be utilized for checking out and reusing various reusable items, such as containers for serving food.

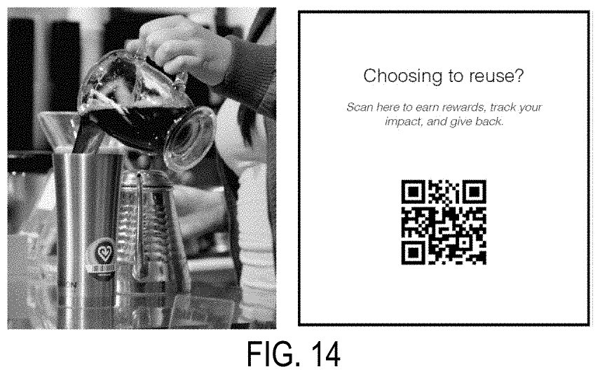

In an embodiment, the check-out method and system utilizes tags or stickers, such as QR codes for example as illustrated in FIG. 14.

In an embodiment, a base module of the system and method includes everything needed to manage a container deposit program focused on food services, in which “anonymous containers” are used. In this case, anonymous containers are not given unique identifiers, but instead are tagged or labelled using a code for the container type. For example, a food services restaurant or cafeteria may tag or label all containers that may be used for serving various different types of meals for lunch. The check-out system and method would then track and manage all lunch containers using aggregate numbers, and would be able to track and answer such questions as” “Were all 100 containers returned today?” and “How many are outstanding?”.

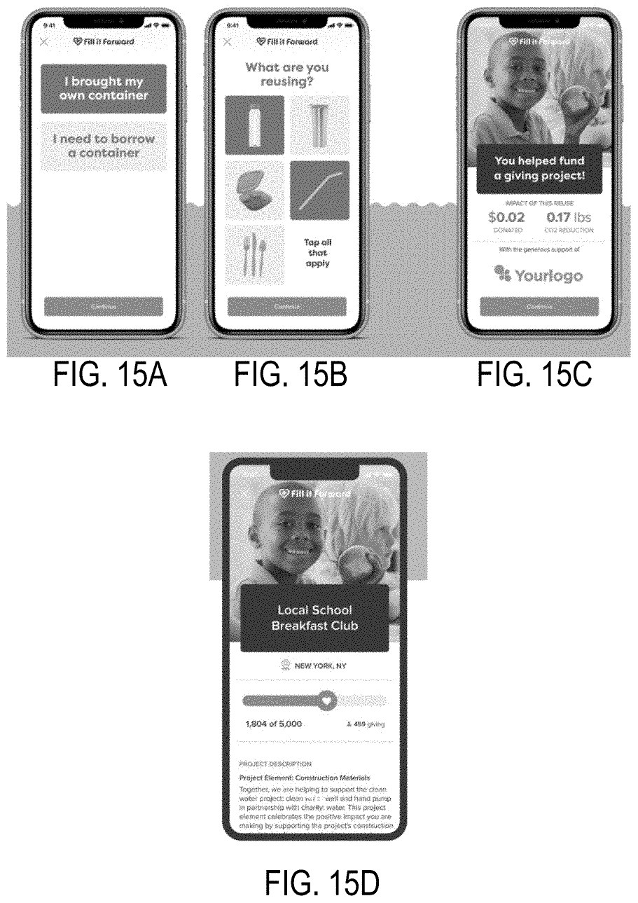

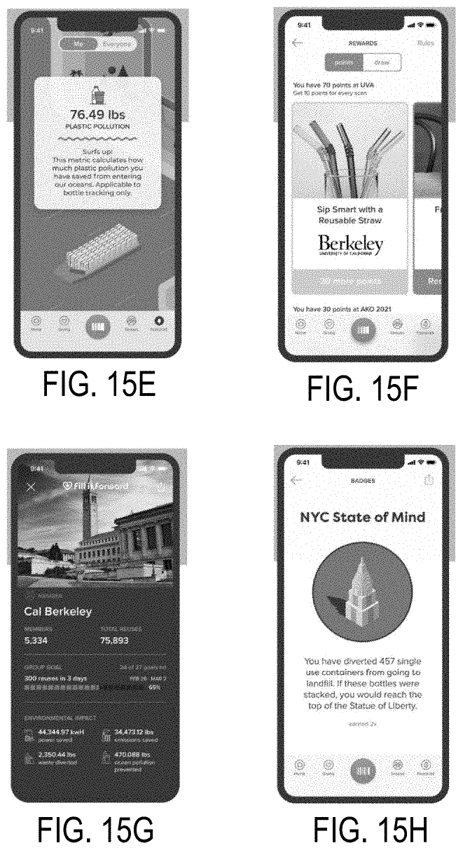

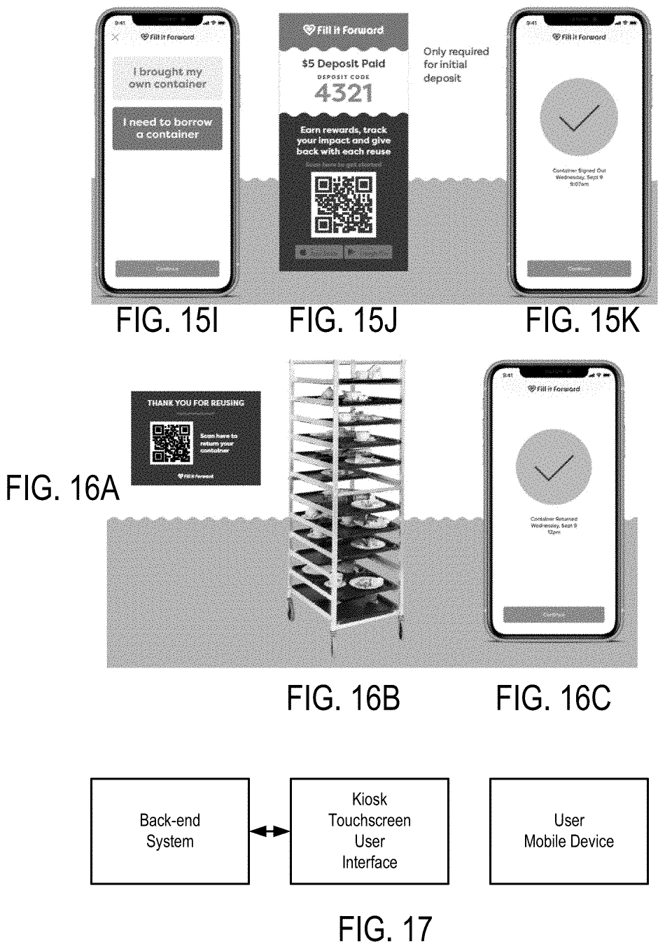

FIGS. 15A to 15K show screen captures of a mobile device illustrating a method and system for reusing in accordance with an embodiment.

FIG. 15A shows a screen asking the user certain selections, such as “I brought my own container” or “I need to borrow a container. The user may also be able to select “A little of both” if the user needs to borrow some items but not all. The user may then be prompted to select an option. In an embodiment, an option may appear on the screen only of the user has signed up for a deposit program, or only if the food services establishment has signed up all users by default.

FIG. 15B shows an illustrative screen in which the user is prompted to tap or select the type of items being reused, including for example a reusable bottle, a reusable cup, a reusable food container, a reusable straw, and/or reusable utensils such as forks, knives, and spoons. The system and method then takes note of the reusable items selected, and calculates various impacts resulting from reuse of the items.

FIG. 15C and FIG. 15D show illustrative screens in which the system and method shows the user a charitable impact of reuse.

FIG. 15E shows an illustrative screen displaying an environmental impact of their reuse, such as the amount of plastic pollution in the oceans that has been prevented.

FIG. 15F shows an illustrative screen displaying a reward that may result from reuse.

FIG. 15G shows an illustrative screen showing the aggregate results of a group, such as a college campus, for example.

FIG. 15H shows an illustrative example of an environmental impact in terms utilizing a graphic illustration, such as calculating the number of single use containers if stacked end to end.

FIG. 15J shows an illustrative example of a screen in which a user has selected “I need to borrow a container”, in which case the system and method calculates a deposit as illustrated in FIG. 15K. Upon successful check-out, the screen in FIG. K shows confirmation that a container has been checked out.

In an embodiment, rather than scanning a code on a borrowed item, the user may simply identify on the screen the type of item being borrowed, for example by selecting a picture or drawing of the item appearing on the screen. In this alternative embodiment, each reusable item need not have a separate tag.

Now referring to FIGS. 16A to 16C, shown is an illustrative example of returning a borrowed item. Upon the user returning the borrowed item to an approved drop off location, the user may scan a code such as a QR code (FIG. 16A) provided on or near a suitable return point, such as a food cart as shown in FIG. 16B. Upon return and the scan of the QR code, the system and method then confirms that the borrowed reusable item has been returned on the user's mobile device (FIG. 16C).

While the above example refers to a food services establishment, it will be appreciated that the system and method may also be applicable to other types of establishments in which reusable items may be borrowed and returned.

By way of illustration and not limitation, the system and method may include the following modules and features, or additional modules and features.

In an embodiment, an inventory tracking module may include additional features required to track individual containers against unique identifiers, such that the system and method can determine “Was container ABC returned today?” “Which participant borrowed container XYZ?”.

In another embodiment, the system and method may allow many participating partners to sign up for the program, such that a user may use the system and method at various different partner sides. In this case, each partner can have their own tags or codes for their own borrowed, reusable items, and track reuse statistics in the aggregate for their individual establishments.

In another embodiment, each participating partner can establish their own check-out, return, deposit and refund policies in order to encourage each user to return borrowed items to their establishment.

In another embodiment, each partner can enable geo-location features, so as to encourage users to return borrowed items to the same location from which they borrowed the item. However, the system and method may also allow the user to return a borrowed item to a different location of the same establishment—for example to another location of the same restaurant chain or chain store in a city or region.

In another embodiment, the system and method may also track borrowed items and provide participating partners that containers have not been returned, and prompt a user that has borrowed an item to return it the restaurant or store. The system and method may also notify the user that their deposit may be kept if the borrowed item is not returned by a certain period of time, or to a certain location. The system and method may keep track of all reminders, and whether or not a borrowed item has been returned as a result.

In an embodiment, when a borrowed item is physically returned to a store, the system and method may prompt the user using the geo-location feature to scan another code at a designated and approved drop-off location, such as a customer service counter or to drop off windows, for example. Upon the user scanning the code, the system and method logs the borrowed item as being returned, and notifies the user via their mobile device screen of any deposit being returned to them.

In another embodiment, the participating partner may also designate a reusable item as being an item that the user can keep in order to reuse at home. In this case, the deposit for the item is retained, and the user is not required to return the item. The item kept by the user may continue to be counted towards an environmental impact, if the user continues to track reuse of that item. For borrowed items that a participating partner wants to be returned, this option to keep and reuse at home may not be available.

In another embodiment, the system and method may track if an item a user is attempting to return is being returned to the proper location or partner. If the system and method detects an error, the system and method may notify the user via their mobile device that the item they are attempting to return cannot be returned, either because it is not the proper location, or some other status flag has been set (e.g. the time to return has expired) to make the return not possible.

In another embodiment, the system and method may track a user's history of returns and provide statistics for the user on that history, and the environmental, social or charitable impact of their return and reuse history. This may be provided on a dashboard, for example, to provide aggregate totals for their returns of borrowed items.

In another embodiment, the system and method may track aggregate numbers for a participating partner, and provide these numbers not only for the partner but also for the user, such that the user knows the environmental, social or charitable impact of the participating partner in the aggregate.

In another embodiment, the system and method may track users who habitually fail to return borrowed items, and in this case the system and method may be configured to provide the user with a warning, or several warnings, after which the system and method may stop the user from being able to borrow additional items unless and until they have returned borrowed items which have not yet been returned.

In another embodiment, the system and method may track the inventory of borrowed and returned items, and initiate reminders or other communication to the user to encourage returns, or to encourage additional borrowing of reusable items based on what they are able to save.

In another embodiment, in addition to a smartphone device, various other devices may be used, such as smartwatches or smart glasses—essentially any device which provides a screen capable of displaying the above described screens, and a user interface capable of allowing the user to select options provided on the screens.

### Kiosk System and Method

In another aspect, the system and method may be implemented on a kiosk platform in which a user may interact with the system via a touch screen user interface. An illustrative block diagram of a kiosk is shown in FIG. 17.

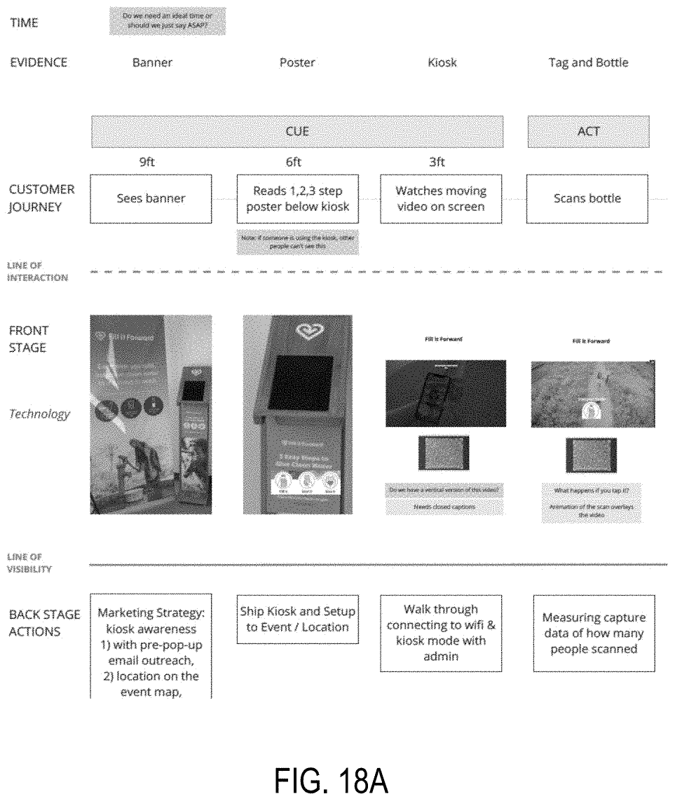

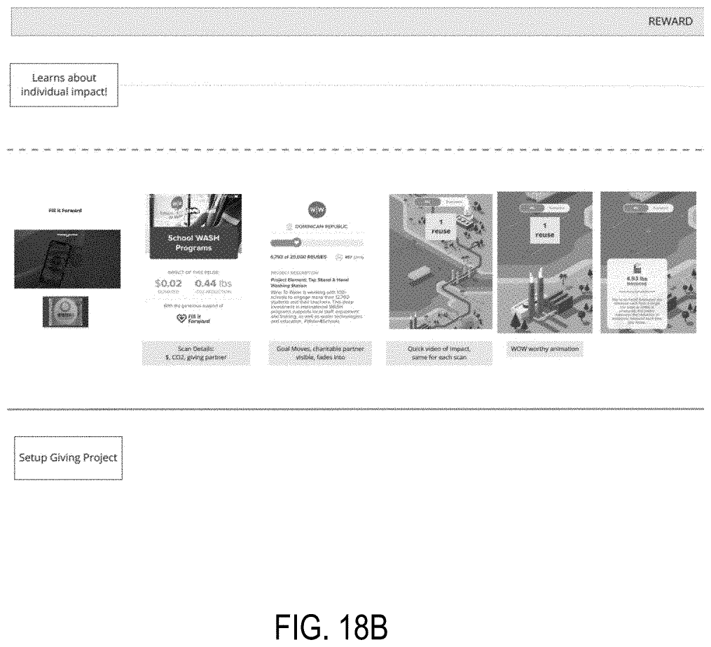

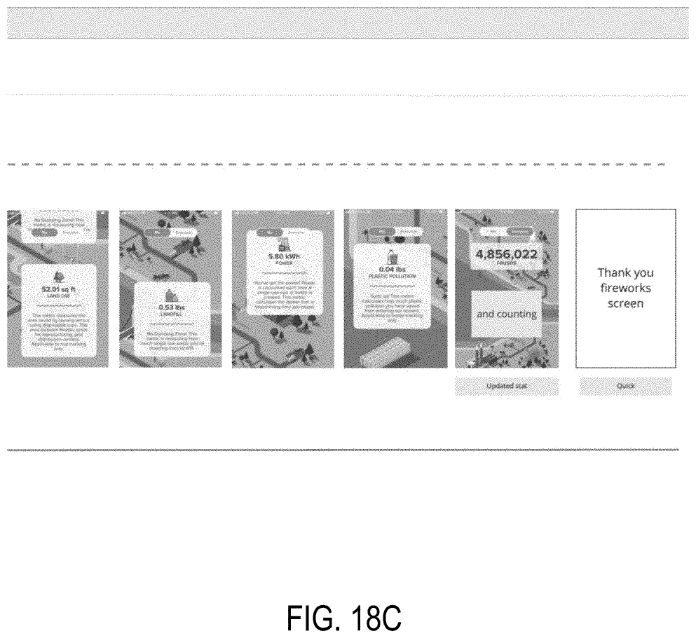

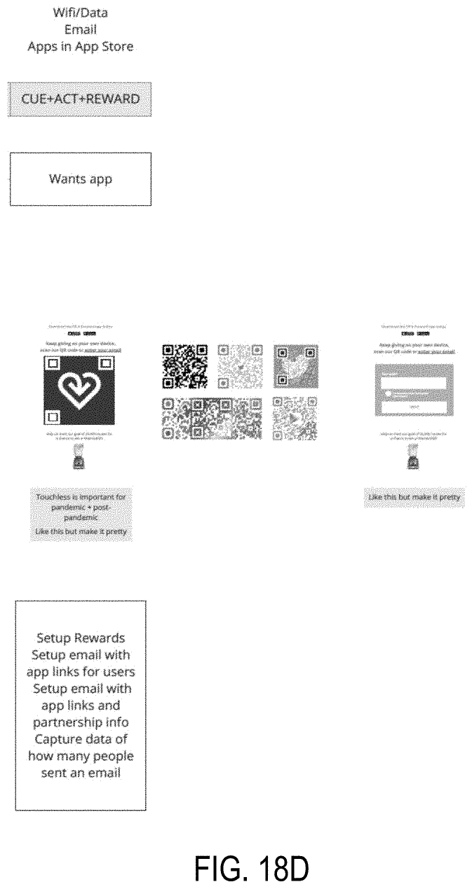

FIGS. 18A to 18D show a schematic flow of how a user may interact with the kiosk in accordance with an embodiment.

In an embodiment, the kiosk is located in an area with significant foot traffic, such as at a market, at a conference, or located within a store or a coffee shop. The kiosk is positioned to draw attention from curious shoppers, people waiting to buy something, or taking a break from work or study.

Still referring to FIGS. 18A to 18D, in an embodiment, the kiosk is configured to draw attention and engage or hook a viewer, such as by displaying a graphic or a video with or without sound. The kiosk may also be configured to provide more information on what it does, and how the viewer can become a user.

In another embodiment, the kiosk is configured to display a screen which informs the view to scan a reusable item, such as a bottle. The kiosk is provided with a scanner, which allows a user to scan an item by positioning a reusable item in front of the scanner. If a user has a bottle to scan, the user scans the item, and immediately provides the user with a value proposition, such as a reward, or the contribution the user is making to an environmental, social, or charitable project.

In another embodiment, the kiosk is also configured to display aggregate data, such as from all of the users who have interacted with the kiosk for example, or the aggregate data collected from multiple kiosks within a community or geographic area, such as a college campus. The user may also be provided with goals for charitable projects, or environmental goals that the system is tracking. The kiosk may display videos or animation illustrating these environmental goals and the impact that the user is making. These videos or animation may track data such as emissions, land use, landfill, power, plastic pollution, and various other measurements of environmental impact.

Still referring to FIGS. 18A to 18D, in another embodiment, the kiosk is configured to prompt the user to provide contact information, such as the user's email. Upon entering the email, the user is asked to consent to receiving information from the system, such as statistical data from the conference, or other information about the system. The information provided to the user may further include a link to an app which may be downloaded by the user.

In another embodiment, the kiosk is configured to display a code, such as a QR code which the user is invited to scan via their mobile device camera. The code may then direct the user to a link providing additional information about the system, and how the user can download an app to their mobile device in order to continue to use the app. The user may also be informed of the rewards and the positive social and/or environmental impact that the user can expect from downloading the app.

### Tracking Recyclable Items

In another aspect, the system and method may be configured to track the recycling of recyclable consumer packaging, such as a cardboard cereal box, for example.

In an embodiment, a cereal box may have a code printed on its cover, which can be scanned by a consumer when the cereal box is placed into a recycling bin for recycling. Similar to tracking any reusable item as described above, the system and method may also track the environmental, social, or charitable impact of recycling an item that cannot be reused. Many of the functions perform by the system and method for reusable items may also apply to recycled items, except for functions relating to returning a borrowed item or reusing an item multiple times. As will be appreciated, apart from cereal boxes, such codes may be placed on any number of recyclable items such as cardboard and plastic, so as to track the amount of recycling performed by a user.

In an embodiment, the type of code used for a recycled item may include certain trackable information, such as the size and weight of the packaging, in order for the system and method to be able to accurately calculate the amount of recyclable material being recycled.

In another embodiment, the system and method may also be configured to provide aggregate recycling data back to the manufacturer or packager, providing feedback on which types of packaging are most often recycled by consumers. By providing such feedback, a manufacturer or packager may be able to improve their packaging designs or choose alternative packaging in order to promote more recycling.

While certain terms have been used to make reference to various reusable containers and carry products, it will be appreciated that these terms are not meant to be limiting, and that the present system and method may be utilized with a full range of reusable products. For example, bags also refers to totes, packs and sacks; boxes also refers to collapsible boxes or cartons; reusable cups also refers to mugs, travel mugs, eco mugs, and eco cups; and reusable bottles also refers to travel bottles, eco bottles, collapsible bottles, etc. In addition, reusable containers may also refer to any type of reusable container for carrying food products or other consumable items. Other types of reusable items that may be tracked using the present system and method include products such as towels, cloth napkins, and utensils, which may be used in place of plastic, cardboard or paper-based disposable products.

Furthermore, it should be understood that various enhancements to the disclosed system, method and computer program are envisioned, and the illustrative embodiments are not meant to be limiting.

Thus, in an aspect, there is provided a system for tracking reusable and recyclable items, the system having a central processing unit, a memory, and a display, the system adapted to: display a user selectable option for reusing one or more reusable items and a user selectable option for borrowing one or more reusable items; upon user selection of the option for reusing one or more reusable items, display one or more impacts resulting from the one or more user selections; and upon user selection of the option to borrowing one or more reusable items, display instructions for checking-out a borrowed item, notify that the borrowed item is successfully checked out, and display one or more impacts resulting from the one or more borrowed reusable items.

In an embodiment, the system is further adapted to calculate and display a combined impact of reusing one or more reusable items, and borrowing one or more borrowed reusable items, thereby to provide feedback of one or more combined cumulative impacts to the user.

In another embodiment, the one or more impacts resulting from the reuse of reusable items and borrowed reusable items comprise a charitable impact, an environmental impact, a reward impact, and a group impact.

In another embodiment, the one or more reusable items are reusable food containers and utensils.

In another embodiment, the system is further adapted to scan a code provide on the one or more reusable food containers and utensils, whereby the system can track inventory of the borrowed reusable items.

In another embodiment, the system is further adapted to calculate an aggregate impact of reusing reusable items and borrowed reusable items for multiple users.

In another embodiment, the system further provides a qualifying location for returning borrowed items, whereby upon returning a borrowed reusable item, the system notifies that the borrowed item is successfully returned.

In another embodiment, the system further comprises a kiosk platform.

In another embodiment, the kiosk platform further includes a scanning module for scanning any borrowed items to be checked out or returned.

In another embodiment, the kiosk platform further includes an option for a user to download an app by providing an email address or scanning a code.

In another aspect, there is provided a method for tracking reusable and recyclable items, the method executable on a device having a central processing unit, a memory, and a display, comprising: displaying on a display a user selectable option for reusing one or more reusable items and a user selectable option for borrowing one or more reusable items; upon user selection of the option for reusing one or more reusable items, displaying on the display one or more impacts resulting from the one or more user selections; and upon user selection of the option to borrowing one or more reusable items, display instructions for checking-out a borrowed item, notifying a user that the borrowed item is successfully checked out, and displaying one or more impacts resulting from the one or more borrowed reusable items.

In an embodiment, the method further comprises calculating and displaying a combined impact of reusing one or more reusable items, and borrowing one or more borrowed reusable items, thereby providing feedback of one or more combined cumulative impacts to the user.

In another embodiment, the method further comprises displaying the one or more impacts resulting from the reuse of reusable items and borrowed reusable items comprises displaying one or more of a charitable impact, an environmental impact, a reward impact, and a group impact.

In another embodiment, the one or more reusable items are reusable food containers and utensils.

In another embodiment, the method further comprises scanning a code provide on the one or more reusable food containers and utensils, thereby tracking an inventory of the borrowed reusable items.

In another embodiment, the method further comprises calculating an aggregate impact of reusing reusable items and borrowed reusable items for multiple users.

In another embodiment, the method further comprises providing a location for returning borrowed items, and upon returning a borrowed reusable item, notifying that the borrowed item is successfully returned.

In another embodiment, the method further comprises providing a kiosk platform.

In another embodiment, the method further comprises providing a scanning module at the kiosk for scanning any borrowed items to be checked out or returned.

In another embodiment, the method further comprises providing an option for a user to download an app by providing an email address or scanning a code.

The scope of the invention is thus defined by the following claims.

1. A system for tracking reusable and recyclable items, the system having a central processing unit, a memory, and a display, the system adapted to:
display a user selectable option for reusing one or more reusable items and a user selectable option for borrowing one or more reusable items;
upon user selection of the option for reusing one or more reusable items, display one or more impacts resulting from the one or more user selections; and
upon user selection of the option to borrowing one or more reusable items, display instructions for checking-out a borrowed item, notify that the borrowed item is successfully checked out, and display one or more impacts resulting from the one or more borrowed reusable items.

2. The system of claim 1, wherein the system is further adapted to calculate and display a combined impact of reusing one or more reusable items, and borrowing one or more borrowed reusable items, thereby to provide feedback of one or more combined cumulative impacts to the user.

3. The system of claim 1, wherein the one or more impacts resulting from the reuse of reusable items and borrowed reusable items comprise a charitable impact, an environmental impact, a reward impact, and a group impact.

4. The system of claim 1, wherein the one or more reusable items are reusable food containers and utensils.

5. The system of claim 3, wherein the system is further adapted to scan a code provide on the one or more reusable food containers and utensils, whereby the system can track inventory of the borrowed reusable items.

6. The system of claim 1, wherein the system is further adapted to calculate an aggregate impact of reusing reusable items and borrowed reusable items for multiple users.

7. The system of claim 1, wherein the system further provides a qualifying location for returning borrowed items, whereby upon returning a borrowed reusable item, the system notifies that the borrowed item is successfully returned.

8. The system of claim 1, further comprising a kiosk platform.

9. The system of claim 8, wherein the kiosk platform further includes a scanning module for scanning any borrowed items to be checked out or returned.

10. The system of claim 9, wherein the kiosk platform further includes an option for a user to download an app by providing an email address or scanning a code.

11. A method for tracking reusable and recyclable items, the method executable on a device having a central processing unit, a memory, and a display, comprising:
displaying on a display a user selectable option for reusing one or more reusable items and a user selectable option for borrowing one or more reusable items;
upon user selection of the option for reusing one or more reusable items, displaying on the display one or more impacts resulting from the one or more user selections; and
upon user selection of the option to borrowing one or more reusable items, display instructions for checking-out a borrowed item, notifying a user that the borrowed item is successfully checked out, and displaying one or more impacts resulting from the one or more borrowed reusable items.

12. The method of claim 11, further comprising calculating and displaying a combined impact of reusing one or more reusable items, and borrowing one or more borrowed reusable items, thereby providing feedback of one or more combined cumulative impacts to the user.

13. The method of claim 11, wherein displaying the one or more impacts resulting from the reuse of reusable items and borrowed reusable items comprises displaying one or more of a charitable impact, an environmental impact, a reward impact, and a group impact.

14. The method of claim 11, wherein the one or more reusable items are reusable food containers and utensils.

15. The method of claim 13, further comprising scanning a code provide on the one or more reusable food containers and utensils, thereby tracking an inventory of the borrowed reusable items.

16. The method of claim 11, further comprising calculating an aggregate impact of reusing reusable items and borrowed reusable items for multiple users.

17. The method of claim 11, further comprising providing a location for returning borrowed items, and upon returning a borrowed reusable item, notifying that the borrowed item is successfully returned.

18. The method of claim 11, further comprising providing a kiosk platform.

19. The method of claim 18, further comprising providing a scanning module at the kiosk for scanning any borrowed items to be checked out or returned.

20. The method of claim 19, further comprising providing an option for a user to download an app by providing an email address or scanning a code.
